(19) United States
(12) Patent Application Publication
(10) Pub. No.: US 2019/0164115 A1
(43) Pub. Date: May 30, 2019

(54) Bar glass tracking system

(71) Applicant: Cody Alexander, Prescott Valley, AZ (US)

(72) Inventor: Cody Alexander, Prescott Valley, AZ (US)

(21) Appl. No.: 15/822,232

(22) Filed: Nov. 27, 2017

(51) Int. Cl. G06Q 10/08; H04L 29/08; H04Q 9/00

(52) U.S. Cl. CPC G06Q 10/087; G06Q 50/12; H04Q 9/00; H04L 67/125

(57) ABSTRACT

A bar glass tracking system, including a trackable glass, a sensor strip to detect when the trackable glass has passed over the sensor strip, and a computing device to communicate with the sensor strip to keep track of a number of times the trackable glass has passed over the sensor strip.

### BACKGROUND OF THE INVENTION

### 1. Field of the Invention

The present general inventive concept relates generally to a bar glass tracking system.

### 2. Description of the Related Art

Bartenders often tend to give away free drinks to their friends and/or regulars, in hopes of receiving larger tips. Also, some bartenders forget to charge customers for drinks when they fill large drink orders. This causes bar owners to lose money due to uncharged drinks being dispensed to the public.

Therefore, there is a need for a system that helps bar owners keep track of how many drinks have been served to customers, so that monetary losses, due to uncharged drinks, are diminished.

### SUMMARY

The present general inventive concept provides a bar glass tracking system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a bar glass tracking system, including a trackable glass, a sensor strip disposed on at least a portion of a bar to detect when the trackable glass has passed over the sensor strip, and a computing device to communicate with the sensor strip to keep track of a number of times the trackable glass has passed over the sensor strip.

The trackable glass may include a glass body have a shape of a bar glass, and a tracking chip embedded within the trackable glass.

The sensor strip may sense when the tracking chip passes over the sensor strip, and sends a signal to the computing device that the tracking chip has passed over the sensor strip.

The bar glass tracking system of claim 3, wherein the computing device may interpret two passes of the tracking chip over the sensor strip as one drink sale.

The computing device may have an application running thereon to allow a user to view how many times the tracking chip has passed over the sensor strip, and to calculate how many drinks should have been tallied during a specific time period.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a bar glass tracking system, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

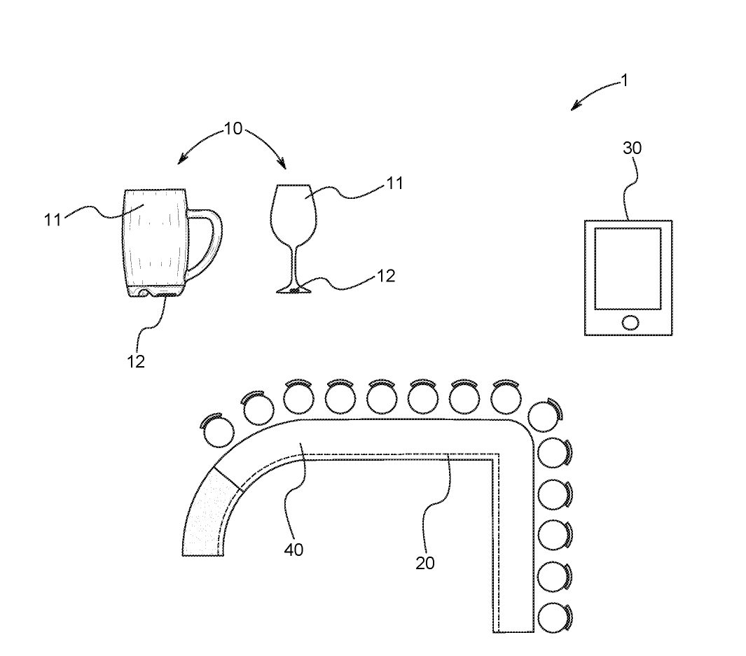

FIG. 1 illustrates a bar glass tracking system 1, according to an exemplary embodiment of the present general inventive concept.

The bar glass tracking system 1 may include a trackable glass 10, a sensor strip 20, and a computing device 30.

The trackable glass 10 may include a glass body 11 and a tracking chip 12. The glass body 11 of the trackable glass 10 may have a shape of any type of glass typically found in a bar (i.e., a bar glass), such as a pilsner glass, a rocks glass, a beer mug, a stein, a wine class, a champagne glass, and a shot glass, but is not limited thereto.

The tracking chip 12 may be installed on or embedded within the trackable glass 10. More specifically, the tracking chip 12 may be included within the trackable glass 10 to be sealed therewithin in a water-proof arrangement and/or setting, so that the trackable glass may be even placed into a dishwasher for cleaning.

The sensor strip 20 may be a sensor device disposed at a portion of a bar 40, such as along an edge of the bar 40 closest to a bartender's side of the bar 40, for example. The sensor strip 20 may detect every time the trackable glass 10 passes over the sensor strip 20. More specifically, the sensor strip 20 may detect when the tracking chip 12 of the trackable glass passes over the sensor strip 20, and may send a signal to the computing device 30 that the tracking chip 12 has passed over the sensor strip 20.

In order to perform the detection, the sensor strip 20 may be communicable with the tracking chip 12 using BLUETOOTH, near field communications (NFC), radio frequency identification (RFID), WIFI, WIFI Direct, 3G, 4G, satellite, or any other type of communication system known to one of ordinary skill in the art.

The computing device 30 may be a computer such as a desktop computer, a laptop computer, a tablet computer, or any other type of computing device, or a mobile device, such as a smart phone, a palm pilot, a BLACKBERRY, or any other type of hand-held device. All of the above devices may have an ability to access the Internet via any available wired or wireless technology, and may include components such as a display device (e.g., touch screed, LED, LCD, plasma, etc.), an input unit (e.g., keyboard, touchpad, mouse, etc.), a camera (e.g., video camera, still camera, etc.), a processor, a storage unit, a communication unit, and an output unit (i.e., speakers, etc.).

The computing device 30 may have an application running thereupon that may be connected to and/or may communication with the sensor strip 20. More specifically, the application running on the computing device 30 may monitor each time the trackable glass 10 passes over the sensor strip 20, and a counter may keep track of how many times the trackable glass 10 has passed over the sensor strip 20.

However, the application may keep track of how many times the trackable glass 10 has passed over the sensor strip 20 two times, and may count those two times as one drink order. In detail, when a bartender passes a customer a drink, the trackable glass 10 must pass over the sensor strip 20 once. When the customer finishes the drink and the bartender retrieves that trackable glass 10, the trackable glass 10 must pass over the sensor strip 20 a second time. Therefore, the application may consider two passes of the trackable glass 10 over the sensor strip 20 as one drink served to a customer.

Furthermore, the application may include a timer that prevents false readings of drinks served. For example, if the sensor strip 20 senses that the trackable glass 10 has passed over the sensor strip twice within 60 seconds, then the second reading is not considered as a proper reading, because the bartender may still be making a drink. In other words, a customer usually requires at least five minutes to finish a drink, so the trackable glass 10 passing over the sensor strip 20 twice within a five minute period, for example, may be interpreted by the application as one drink served.

The computing device 30 may allow a user to use the application to change settings of the detections, such as changing the five minute time period to a two minute time period, for example. Also, the application running on the computing device 30 may also produce automatic calculations of drink price totals that should have been acquired by the bar, so that the bar owner can easily, view differences between amounts actually collected versus amounts that should have been collected.

Therefore, the application running on the computing device 30 may allow a user to view how many times the tracking chip 12 has passed over the sensor strip 20, and also, may automatically calculate how many drinks should have been tallied during a specific time period.

Additionally and optionally, a door at an entrance of a bar may include a sensor strip that causes an alarm to sound if the trackable glass 10 passes through the door, in order to help prevent theft of the trackable glass 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A bar glass tracking system, comprising:
a trackable glass;
a sensor strip disposed on at least a portion of a bar to detect when the trackable glass has passed over the sensor strip; and
a computing device to communicate with the sensor strip to keep track of a number of times the trackable glass has passed over the sensor strip.

2. The bar glass tracking system of claim 1, wherein the trackable glass comprises:
a glass body have a shape of a bar glass; and
a tracking chip embedded within the trackable glass.

3. The bar glass tracking system of claim 2, wherein the sensor strip senses when the tracking chip passes over the sensor strip, and sends a signal to the computing device that the tracking chip has passed over the sensor strip.

4. The bar glass tracking system of claim 3, wherein the computing device may interpret two passes of the tracking chip over the sensor strip as one drink sale.

5. The bar glass tracking system of claim 4, wherein the computing device has an application running thereon to allow a user to view how many times the tracking chip has passed over the sensor strip, and to calculate how many drinks should have been tallied during a specific time period.
